(19) United States
(12) Patent Application Publication
(10) Pub. No.: US 2004/0265465 A1
(43) Pub. Date: Dec. 30, 2004

(54) Cold de-aeration in production of citrus juices

(75) Inventors: Thomas C. Daniels, Bradenton, FL (US); John P. Botting, Tampa, FL (US)

Correspondence Address: Cook, Alex, McFarron, Manzo,, Cummings & Mehler, Ltd., Suite 2850, 200 West Adams Street, Chicago, IL, 60606, US

(73) Assignee: Tropicana Products, Inc.

(21) Appl. No.: 10/609,840

(22) Filed: Jun. 30, 2003

(51) Int. Cl. A23L 2/00

(52) U.S. Cl. 426/599

(57) ABSTRACT

A continuous process for cold de-aeration of citrus juice wherein the juice is at a temperature between 32° F. and 50° F. and is subjected to a vacuum of between approximately 28 and 30 inches mercury for 10 to 20 minutes to produce a de-aerated citrus juice.

The present invention is directed to a continuous process for cold de-aeration of citrus juices. More particularly, the present invention is directed to a continuous process for de-aerating citrus juice wherein the juice is cooled to a temperature between 32° F. and 50° F. and is subjected to a vacuum of between approximately 28 and 30 inches mercury for 10 to 20 minutes to produce a de-aerated citrus juice.

### BACKGROUND OF THE INVENTION

When producing citrus juice, and in particular not from concentrate (NFC) citrus juice such as NFC orange juice, the shelf stability of the juice is an important concern. Shelf stability includes not only maintaining the flavor of the juice but also preventing spoilage of the juice so that it remains fit for human consumption. One of the factors affecting the shelf stability of the juice is the amount of chemical oxidation which occurs during storage of the juice. It is preferable to minimize any chemical oxidation during storage by reducing the dissolved oxygen level in the juice. The goal is to obtain a dissolved oxygen level in the juice of from 0 to 0.5 ppm. One technique used during production to reduce the dissolved oxygen level in the juice is to de-aerate the juice.

Currently, de-aeration during commercial production of NFC citrus fruit juice is done at a warm temperature, such as for example 100° F. to 140° F. (37.78° C. to 60° C.), for approximately 1 minute. Unfortunately, such a hot process thermally abuses the juice which adversely affects the quality of the juice. Additionally, some of the volatiles, such as oils, in the juice are stripped out, meaning that the juice is adversely changed during the process. Further, such a process usually does not sufficiently remove the dissolved oxygen to meet the targeted goal of 0-0.5 ppm dissolved oxygen.

A prior technique for de-aerating juice is disclosed in U.S. Pat. No. 1,980,695 (Polk). This patent describes a complete batch process for extraction and treatment of orange juice. One step in that process is a de-aeration of the juice to eliminate the contained air in the juice, and its oxidizing effect, and to eliminate oily and other contaminating impurities in the juice. In the process in Polk, the juice passes from a fore-cooler and settling container to a vacuum separator chamber. The vacuum separator is then filled to the desired amount, and the inlet valve to the vacuum separator chamber is then closed. This device has an upright cylindrical form with a cooling jacket wherein a body of juice may be maintained under high vacuum at a temperature approximating the freezing point. Specifically, the vacuum separator chamber maintains a partial vacuum of at least 27 inches mercury vacuum gauge (3 inches absolute pressure) and preferably 28 inches vacuum gauge or higher. The juice in this step is at a temperature of 29° F. to 33° F. (−1.67° C. to 0.5° C.), but optimally 30° F. (−1.11° C.). The juice is then slowly agitated for a few minutes to dislodge pulp. The juice then stands quietly in the vacuum separator chamber at this high pressure for 15 minutes. This causes the fairly coarse pulp and other suspended solid or semi-solid material to rise upward through the juice and accumulate in a layer at the upper surface of the juice. The top portion of the juice is then removed. The vacuum is then slowly released, the valve at the bottom of the chamber is opened, and the juice is allowed to flow to a filling machine. The process disclosed in Polk, however, is limited to a batch process. Such a batch process is expensive, slow, inefficient and of little use in today's mass manufacturing of citrus juice. Instead, a continuous process for production of juice is preferred.

A later patent, U.S. Pat. No. 5,006,354 (Rahrooh et al.), also describes a de-aeration process for use during the manufacture of fruit juices. In this patent, de-aeration is done in two steps, one on a concentrated source of the fruit juice and one on the water. The de-aeration of the water is done by heating the water to around the boiling temperature of water or by heating under vacuum conditions at a pressure of 0.1 bar (2.95 inches mercury) at a temperature of 50° C. to 60° C.(122° F. to 140° F.) for 1 minute to 3 minutes. The concentrated juice source is de-aerated at a temperature below 30° C. (86° F.) and preferably in a range of from 0° C. to 5° C. (32° F. to 41° F.) in a vacuum condition at 0.1 bar, preferably in the range of from 3 minutes to 6 minutes. Such a two step operation is expensive, inefficient and accordingly, undesirable.

Accordingly, it is an object of the present invention to provide a de-aeration method for use during the continuous commercial mass production of citrus juice which minimally changes the juice and improves the quality of the resulting juice.

### SUMMARY OF THE INVENTION

The present invention is directed to a method for de-aeration of citrus juice during the continuous production of such juice.

In a preferred embodiment of the present invention, the method comprises the steps of cooling citrus juice to a temperature between approximately 32° F. to 50° F. (approximately 0° C. to 10° C.) and filling a tank, chamber, container or similar type of apparatus with a desired volume of chilled juice. The tank is maintained at a vacuum of between approximately 28 to 30 inches mercury (Hg). Once the tank is filled to the desired level, juice is continually added and removed from the tank at approximately equal rates, resulting in the juice residing in the tank for a period of approximately 10 to 20 minutes before being removed, and the process being a continuous process. This method results in the juice leaving the tank having been de-aerated and having a reduction in the dissolved oxygen level of the juice to between 0 to about 0.5 ppm.

By de-aerating in the temperature and vacuum ranges of the method of the present invention, the citrus juice is exposed to lower thermal abuse, and as a result, a higher quality citrus juice is produced. An embodiment of the present invention is directed to a better tasting juice produced by this method.

Additionally, by operating at a lower temperature, the volatiles in the citrus juice are harder to strip away during de-aeration. As a result, the juice exiting the de-aeration process of the present invention is less changed by the process, and a higher quality citrus juice is produced. A further embodiment of the present invention is directed to a better tasting citrus juice that does not have the volatiles in the juice stripped out.

### BRIEF DESCRIPTION OF THE DRAWINGS

FIG. 1 is a schematic drawing showing a de-aeration tank of one embodiment of the present invention.

### DETAILED DESCRIPTION OF THE PRESENTLY PREFERRED EMBODIMENTS

The present invention is directed to de-aeration during the production of citrus juice, particularly during commercial, mass-production of citrus juice. More specifically, the present invention is directed to a continuous process for de-aeration of citrus juice. Preferably the present invention is directed to the production of citrus juice, such as orange, grapefruit, tangerine, lemon and combinations or blends thereof, and preferably NFC citrus juice. More preferably, the juice is orange juice and even more preferably NFC orange juice.

In the method of the present invention, in order to de-aerate the juice, the juice is chilled to a cold temperature between approximately 32° F. to 50° F. (approximately 0° C. to 10° C.) and preferably between approximately 32° F. to 38° F. (approximately 0° C. to 3° C.). The juice is also held at a vacuum of between approximately 28 to 30 inches Hg (approximately 1 bar). In a preferred embodiment, the vacuum is held at 28 inches Hg. Preferably, the residence time of the juice at this temperature and vacuum is between 10 to 20 minutes. The result is a reduction in the dissolved oxygen level within the juice to a level of between 0 to about 0.5 ppm. In a preferred embodiment, the method of the present invention is performed in a de-aerator, such as a de-aeration tank, prior to pasteurization of the juice. An example of such a tank is an APV-standard 24″ vacuum tank.

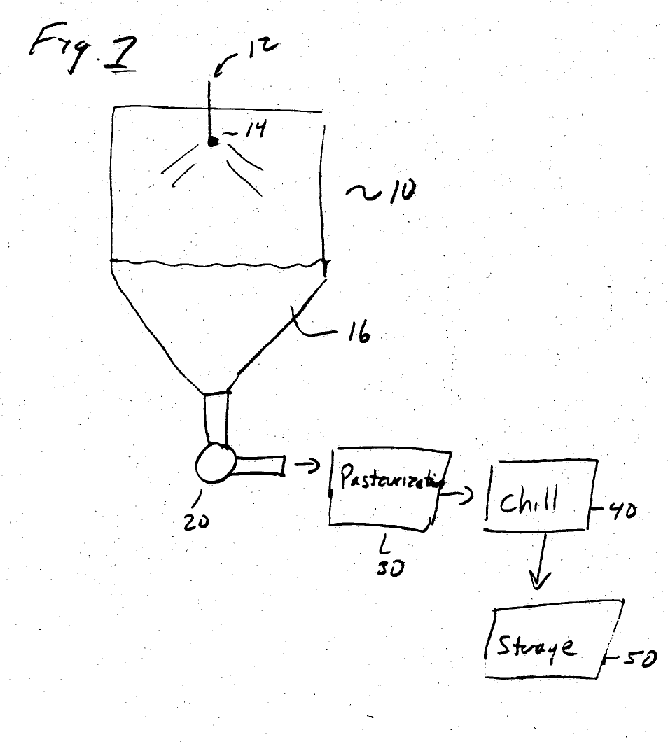

FIG. 1 illustrates a de-aeration tank 10 that can be used with the method of the present invention. Preferably, prior to entering the tank, the juice is chilled to a temperature between approximately 33° F. to 50° F., preferably between approximately 32° F. to 38° F., in a conventional manner. Raw, chilled citrus juice then enters the tank 10 at inlet 12. The tank is at a vacuum of between approximately 28 to 30 inches of Hg, preferably about 28 inches Hg. Preferably, a consistent vacuum of 28 to 30 inches of Hg is kept on the tank at all times, except to prime the extraction pump, to maintain the desired vacuum. In a preferred embodiment, an atomizing nozzle assembly 14 is located in the upper portion of the tank. The raw juice is sprayed into the tank through the atomizing nozzle 14. Preferably, a WhirlJet® #3 nozzle is used as the atomizing nozzle. Such a nozzle creates a spray pattern that allows the juice additional dwell time on the sidewall of the tank to aid in the removal of trapped oxygen in the juice. A thin film of juice can be formed on the sidewall.

Once the juice reaches a desired volume in the tank, juice is extracted at the same rate that it continues to enter the tank. By extracting the juice at the same rate as it enters the tank, the production process for making juice is able to be run continuously without stopping the process for de-aeration, while still achieving the desired de-aeration of the juice. Therefore, it is not necessary to run the process as a batch process.

Preferably, the juice 16 resides in the de-aeration tank for 10 to 20 minutes at a vacuum of between 28 to 30 inches Hg and at a temperature of between approximately 32° F. to 50° F., and more preferably at 28 inches of Hg and at a temperature between 32° F. to 38° F. After residing in the tank at this vacuum and temperature for this period of time, the exiting juice is de-aerated, and the dissolved oxygen level in the exiting juice is between approximately 0 to 0.5 ppm. Preferably, the de-areated juice exits at the bottom of the tank.

The other steps for production of the juice can be those conventionally known in the art. For example, in a typical production, the de-aerated juice will leave de-aeration tank 10 and travel to a pump 20. From pump 20, the juice will then be pasteurized at 30, chilled at 40 and sent to storage 50.

### EXAMPLE

An APV de-aerator tank, modified with a WhirlJet® #3 nozzle was used in this Example. Initially, NFC orange juice was chilled to a temperature of 35° F. The chilled juice was then sent to the de-aerator tank. The tank was maintained at a vacuum of between 28 to 30 inches Hg. The flow rate of juice into and out of the tank was 1.20 gal/min resulting in a hold-up volume of 20 gallons residing in the tank. This resulted in the juice being in the tank for approximately twenty (20) minutes before exiting. The test resulted in an average of 0.545 ppm of dissolved oxygen content in the juice exiting the tank. This is insignificantly above the desired level and illustrates that successful de-aeration was achieved under these conditions which are relatively mild and do not harshly treat the sensory qualities of the juice.

It will be understood that the embodiments and examples of the present invention, which have been described, are illustrative of some of the applications of the principles of the present invention. Numerous modifications may be made by those skilled in the art without departing from the spirit and scope of the invention.

1. A process for continuous de-aerating of citrus juice comprising:
cooling a citrus juice to a temperature between approximately 32° F. to 50° F. (approximately 0° C. to 10° C.);
filling a tank with a desired volume of said cooled juice, wherein said tank is maintained at a vacuum of between approximately 28 to 30 inches mercury;
continually adding said cooled juice to said tank; and
removing juice from said tank at a rate approximately equal to the rate said cooled juice is added to said tank,
wherein said cooled juice resides in said tank for a period of approximately 10 to 20 minutes before being removed, and
wherein said juice being removed from said tank is de-aerated citrus juice.

2. The process of claim 1 wherein said juice is not from concentrate citrus juice.

3. The process of claim 1 wherein said juice is selected from the group consisting of orange, grapefruit, tangerine, lemon and combinations thereof.

4. The process of claim 2 wherein said juice is selected from the group consisting of orange, grapefruit, tangerine, lemon and combinations thereof.

5. The process of claim 1 wherein said juice is added to said tank by atomizing said juice.

6. The process of claim 1 wherein said juice is cooled to a temperature between approximately 32° F. to 38° F. (approximately 0° C. to 3° C.).

7. The process of claim 6 wherein said tank is maintained at a vacuum of approximately 28 inches mercury.

8. The process of claim 1 wherein said juice removed from said tank has a dissolved oxygen level between approximately 0 to approximately 0.5 ppm.

9. The process of claim 1 wherein said tank is a de-aerator tank.

10. A process for continuous de-aerating of juice comprising:
filling a tank with a desired volume of juice which is at a temperature between approximately 32° F. to 50° F. (approximately 0° C. to 10° C.), wherein said tank is maintained at a vacuum of between approximately 28 to 30 inches mercury;
continually adding said juice to said tank; and
removing juice from said tank at a rate approximately equal to the rate at which said juice is added to said tank,
wherein said juice resides in said tank for a period of approximately 10 to 20 minutes before being removed, and
wherein said juice being removed from said tank is de-aerated juice.

11. The process of claim 10 wherein said juice is not from concentrate citrus juice.

12. The process of claim 10 wherein said juice is added to said tank by spraying said juice such that at least a portion thereof forms a thin film of juice on a sidewall of the tank.

13. The process of claim 10 wherein said juice is cooled to a temperature between approximately 32° F. to 38° F. (approximately 0° C. to 3° C.) prior to filling some into the tank.

14. The process of claim 13 wherein said tank is maintained at a vacuum of approximately 28 inches mercury.

15. The process of claim 10 wherein said juice removed from said tank has a dissolved oxygen level between approximately 0 to approximately 0.5 ppm.

16. A de-aerated juice made by a process comprising:
filling a tank with a desired volume of a juice at a temperature between approximately 32° F. to 50° F. (approximately 0° C. to 10° C.) while maintaining the tank at a vacuum of between approximately 28 and 30 inches mercury;
continually adding said juice to said tank; and
removing juice from said tank at a rate approximately equal to the rate at which said juice is added to said tank,
such that said cooled juice resides in said tank for a period of approximately 10 to 20 minutes before being removed; and
said juice being removed from said tank is de-aerated juice.

17. The juice of claim 16 wherein said juice is not from concentrate citrus juice.

18. The juice of claim 17 wherein said juice is selected from the group consisting of orange, grapefruit, tangerine, lemon and combinations thereof.

19. The juice of claim 16 wherein said juice filled into a tank is at a temperature between approximately 32° F. and 38° F. (approximately 0° C. to 3° C.).

20. The juice of claim 1 wherein said juice removed from said tank has a dissolved oxygen level between approximately 0 to approximately 0.5 ppm.
